(19) United States
(12) Patent Application Publication
(10) Pub. No.: US 2025/0204305 A1
(43) Pub. Date: Jun. 26, 2025

(54) HAULM LIFTING AND SEPARATING APPARATUS

(71) Applicant: MSR TECHNOLOGY APS, Thisted (DK)

(72) Inventor: Michael STOLBERG-ROHR, Thisted (DK)

(73) Assignee: MSR TECHNOLOGY APS, Thisted (DK)

(21) Appl. No.: 18/848,767

(22) PCT Filed: Mar. 20, 2023
(86) PCT No.: PCT/EP2023/057092

§ 371 Date: Sep. 19, 2024

(30) Foreign Application Priority Data
Mar. 21, 2022 (DK) PA202270118
Apr. 13, 2022 (DK) PA202270202

(51) Int. Cl. A01D 33/06

(52) U.S. Cl. CPC A01D 33/06

(57) ABSTRACT

A haulm lifting and separating apparatus for separating haulms of rows of crops, possibly on ridges, said apparatus having a direction of travel and comprising at least one moving separating means in the form of a reciprocating or circulating, possibly circular, element adapted to be positioned next to a row of crops and comprising a series of peripheral protrusions reciprocating or circulating in a plane parallel to the direction of travel and extending upwards, said protrusions defining an area of passage; a ground abutment positioned next to a lower portion of the area of passage to define the position of said lower portion relative to the ground; a drive for the reciprocating or circulating element; and preferably a shear positioned next to a periphery of the area of passage.

### CROSS REFERENCE TO RELATED APPLICATIONS

The instant application is a U.S. National Stage application of and claims priority to PCT/EP2023/057092, filed on Mar. 20, 2023, which is a PCT application of and claims priority to both DK Application No. PA202270202, filed on Apr. 13, 2022, and DK Application No. PA202270118, filed on Mar. 21, 2022, the subject matter of each aforementioned application is hereby incorporated by reference in their entireties.

### FIELD OF THE INVENTION

The present invention relates to agriculture and especially to a haulm lifting and separating apparatus, for example, as a precursor to a haulm cutting apparatus for cutting haulms of crops growing in rows.

### BACKGROUND OF THE INVENTION

Some crops, for example, potatoes, tend to grow long stems, stalks, or haulms, for example, 1½-2 meters long, providing a tangled layer of haulms in a field, such tangled layer even spanning between different rows of crops, making work in the field for example. haulm cutting, difficult.

In different fields of agriculture haulms need to be cut at certain times during the season.

For example, in potato farming haulms need to be cut at a time prior to harvest to promote the development of the new potatoes in the ground rather than the development of the haulms above the ground. The cutting of the haulm is done to ensure ripening of the potatoes in the ground in order to make later handling possible with minimum damage to the potatoes, and also to keep the potatoes from growing larger than the desired size.

Further, for example, in cotton faming haulms or plant parts above the ground need to be removed after harvest in preparation for the next growth season and harvest. In so-called no-tilling cotton farming whereby it is avoided to plough or cultivate the soil, it is known to remove the haulms or plant parts above the ground by use of chemicals.

WO 2020/164672 A1, incorporated herein in its entirety by reference, discloses a haulm cutting apparatus comprising lateral and vertical guiding means or surfaces and a first, rotatable shear rotatable around an axis of rotation extending in a direction with a vertical component. The apparatus further comprises a counter shear for cooperation with the first, rotatable shear, and the first, rotatable shear and the counter shear are positioned in a side-by-side relationship relative to a direction of travel during operation. The shears are cutting the haulms during operation.

U.S. Pat. No. 4,416,334 discloses a potato harvesting apparatus comprising disk coulters that separate and cut the vines between the rows of potatoes.

EP 3 530 104 A1 discloses a header, such as a grain header, having lateral crop dividers that in operation will gently lift and divide standing or down crop material by performing a raking function.

U.S. Pat. No. 6,264,554 B1 discloses a vertical crop cutting apparatus for attachment to an agricultural cutting bar for cutting entangled crops such as rape, for example, canola; peas; or mustard. The vertical crop cutting apparatus comprises a rotor which is a circular plate having blades bolted about the periphery. A forward edge of a housing includes stationary blades, said housing and a guard member extending down beyond the rotor. As the rotor blades are rotated past the stationary blades the resulting cutting action is scissor like. The rotor is shielded from the ground by the housing extending downwards beyond the periphery of the rotor including its blades. A collecting member in the form of an elongate rod is mounted to extend forwardly at an upward incline from the housing to deflect the crop downwardly into the blades as the header is advanced forwardly through the crop in the working direction. The vertical crop cutting apparatus is adapted to be mounted on the end of a header at an adjustable height and angle.

EP 3 732 948 A1 relates to a cutting unit for cutting for example, rape, comprising a horizontal cutter bar with vertical finger cutter bars at the lateral ends thereof.

NL 7905829 A discloses a multirow potato plant defoliator comprising pairs of contra-rotating rollers having axes of rotation extending at a downward angle in the direction of travel said rollers being adapted to catch foliage between them to pull up and tear said foliage. Spear-like bend elements extend in prolongation in front of the rollers to guide the foliage.

It is the experience of the present inventor that such spear-like, forward pointing elements are prone to get caught and stuck resulting in wreckage or breaking up the soil potentially revealing potatoes in the ground subjecting the same to sunlight, which ruins the potatoes. Such problems are especially seen if the forward speed during operation is too high.

### SUMMARY OF THE INVENTION

The object of the present invention is to facilitate work in a field comprising a tangled layer of haulms of crops growing in rows, for example, potatoes.

According to the invention, a haulm lifting and separating apparatus for lifting and separating haulm of rows of crops in an agricultural field comprising crops growing in rows, possibly on ridges, said apparatus being adapted for lifting and separating the haulms prior to said haulms being separated from their respective roots, said apparatus having a direction of travel in operation, and said apparatus comprising at least one driven moving haulm engaging element that is unshielded towards the ground, said haulm engaging element being in the form of a circulating, possibly circular, element adapted to be positioned next to a row of crops, said circulating element comprising a series of peripheral haulm engaging protrusions circulating in a plane, said plane preferably extending generally parallel to the direction of travel and extending upwards in a direction with a vertical component, said haulm engaging protrusions defining an area of passage during reciprocating or circulation; at least one driven moving haulm separating means in the form of a reciprocating or circulating, possibly circular, element adapted to be positioned next to a row of crops, said reciprocating or circulating element comprising a series of peripheral haulm separating protrusions reciprocating or circulating in a plane, said plane extending upwards in a direction with a vertical component; a ground abutment positioned next to a lower portion of the area of passage to define the position of said lower portion relative to the ground; at least one drive for driving the reciprocating or circulating element(s); and preferably a shear positioned next to a periphery of the area of passage. Such shear is, for example, positioned laterally next to a periphery of the area of passage.

In some embodiments the haulm engaging element and the haulm separating means are one and the same. Thus, the same element performs the task of engaging, thereby preferably lifting, and separating, preferably by cutting, the haulms.

In other embodiments the haulm engaging element is an individual element relative to the haulm separating means. Thus, the haulm engaging element may lift the haulms and deliver the haulms to the haulm separating means for the haulms to be separated, preferably cut, thereby.

The haulm lifting and separating apparatus may be a potato haulm lifting and separating apparatus.

In an embodiment the haulm lifting, and separating apparatus is adapted for peripheral protrusions to touch or dig slightly into the ground. This especially applies to peripheral haulm engaging protrusions of a circulating element.

In the case of circulating elements related to either the haulm engaging element or to the haulm separating means, forward edges of the protrusions, relative to the direction of rotation, are for example, leaning forward in the direction of rotation relative to a radial direction and/or they are for example, concave to facilitate capture of haulms during the circulating movement the protrusions. Thus, during the circulating movement of the circulating element, and thereby of the protrusions, for example, at a relatively high speed, the latter will catch haulms at a low level determined by the ground abutment and lift and possibly tear the haulms, possibly in cooperation with a shear when such is present next to the periphery of the area of passage of the protrusions.

In the case of circulating elements, applying a shear next to the area of passage entails that the haulms are cut rather than torn which in turn entails that the haulms are not crushed substantially, and sap or juices of the haulms are not spread, whereby is obtained that is case of for example, fungal infestation such infection is not spread over the field, washed into the soil (by rain) and hence contaminate the tubers. Such infection might affect the shelf-life of the tubers and next year's seed pieces, which for example, in ecological agriculture might entail that next year's crops risk an infection. In connection herewith the shear next to the area of passage may for example, be a haulm separating means in the form of a reciprocating element, such as a finger cutter bar.

In some embodiments the shear positioned next to a periphery of the area of passage is stationary during operation.

The ground abutment may for example, be a ski-like skid or a roller or wheel. Thus, the ground abutment should be able to ride over the ground and avoid getting stuck in the ground.

In an embodiment wherein at least one of the reciprocating or circulating element relating to the haulm engaging element and/or to the haulm separating is a circulating element, the drive for said circulating element is adapted to drive the circulating element in a direction of circulation whereby the haulm engaging protrusions and/or haulm separating protrusions are moving in the direction of travel at the lower portion of the area of passage. Hereby the protrusions may on engagement with a haulm perform a lifting effect thereon before separation thereof.

In an embodiment two of said circulating elements are arranged as a twin-element comprising two series of peripheral protrusions reciprocating or circulating in respective, mutually parallel planes, and preferably at least part of the abutment as a common abutment is positioned between the parallel planes.

In an embodiment, two of said circulating elements are arranged as a twin-element comprising two series of peripheral protrusions circulating in respective, mutually parallel planes, preferably at least a part of the drive being arranged between the parallel planes, and preferably shears are arranged between the parallel planes. Hereby lifting and tearing or cutting of the haulms are further facilitated.

In an embodiment, two reciprocating or circulating elements are adapted to be positioned on either side of the row of crops. Hereby the subsequent cutting of the haulms of the row of crops is more effectively facilitated in one pass of the haulm lifting and separating apparatus. In a further embodiment the two reciprocating or circulating elements on either side of the row of crops are adapted to move independently up and down to be able to follow the contour of the field on the respective sides of the row of crops independently.

In an embodiment, behind the circulating element relative to the direction of travel, a haulm lifting element is arranged between the track of the reciprocating or circulating element and a vertical plane intended to extend along and through the centre of the row. Such haulm lifting element may further lift and centre the haulms thereby further facilitating subsequent cutting of the haulms of the row of crops from the roots of the crops.

In a further embodiment the haulm lifting, and separating apparatus comprises a second ground abutment for guiding the haulm lifting element and the haulm lifting element is movable relative to the haulm separating means in a plane perpendicular to the direction of travel.

In a further embodiment, such haulm lifting element is a driven, circulating, preferably rotating element. A roller, for example, like one of the counter rotating rollers disclosed in the above-mentioned NL 7905829 A may be used as a haulm lifting element.

In another further embodiment, the haulm lifting element is formed as a wheel with peripheral, second protrusions. Such wheel may be attached to a driving element at one side have the opposite side facing the ground, for example, the slanted ground of a ridge. The side of the wheel facing the ground may be plane or it may for example, be concave for the protrusions to be positioned closer to the ground than the centre of the wheel. Further the wheel may be positioned with its side facing the ground parallel to the ground or said side may be tilted slightly relative to the ground for example, for the leading part of said side, relative to the direction of travel during operation, to be positioned closer to the ground than the trailing part.

In an embodiment, a haulm lifting and separating apparatus according to the present invention may be combined with a haulm cutting apparatus.

Thus, in an embodiment, a haulm lifting, and separating apparatus comprises a defoliating device for separating the haulms from the roots of the crops, said defoliating device being positioned to be placed centrally relative to the row of crops to be processed and behind the reciprocating or circulating element relative to the direction of travel in operation. Hereby the preparation for cutting of haulms and the cutting of haulms proper may be performed in one pass of the field.

In a further embodiment, the defoliating device is a haulm cutting apparatus comprising a first, rotatable shear rotatable around an axis of rotation extending in a direction with a vertical component, and a counter shear for cooperation with the first, rotatable shear, wherein the first, rotatable shear and counter shear are positioned in a side-by-side relationship relative to the direction of travel. Such haulm cutting apparatus is per se known from WO 2020/164672 A1, which is incorporated herein in its entirety by reference.

In a further embodiment, the haulm lifting, and separating apparatus comprises lateral and vertical guiding means for guiding the defoliating device relative to the crops, and in a still further embodiment the lateral and vertical guiding means comprise abutment surfaces for abutment on opposite slanted ground surfaces of a ridge.

The haulm lifting and separating apparatus comprising on one hand ground abutment(s) for controlling the position of the peripheral protrusions of the circulating element(s) relative to the ground in the lower part of the area(s) of passage, and comprising on the other hand lateral and vertical guiding means for guiding the defoliating device, provides for either constructing the haulm lifting and separating apparatus with the circulating element(s) and the defoliating device mounted in fixed positions relative to each other, or the circulating element(s) and the defoliating device may be able to move relative to each other for example, in the vertical direction.

When such relative movement is facilitated, the haulm lifting element(s), when present, may be mounted in fixed positions relative to either the circulating element(s) or the defoliating device.

In an embodiment including a defoliating device in the form of a first rotatable shear a counter shear, at least one of the first, rotatable shear and the counter shear may comprise a circular disc with a recessed rim portion. Especially, both the first shear and the counter shear may be rotatable shears, each comprising a circular disc with a recessed rim portion and further being rotated at different rotational speeds as it is per se known from WO 2020/164672 A1, which is incorporated herein in its entirety by reference.

In an embodiment, a spraying device is included with a nozzle provided behind the defoliating device, preferably for spraying a weeding agent onto residuals of haulms. When removing the haulms from the roots by a defoliating device, for example, a haulm cutting apparatus, it may be intended that growth should be stopped to prevent the plant from growing new haulms, for example, to instead promote the growth and development of the crop proper, for example, potatoes. Whereas defoliating or haulm cutting may be intended as an alternative to a chemical treatment, a slight chemical treatment may be added by this embodiment.

### BRIEF DESCRIPTION OF THE DRAWINGS

In the following the invention will be explained in further detail by means of examples of embodiments having reference to the accompanying schematic drawings, in which:

FIG. 1 is a side view of a haulm lifting and separating apparatus according to the invention attached to a tractor;

FIG. 2 is an enlarged side view of the haulm lifting and separating apparatus of FIG. 1 omitting the tractor;

FIG. 3 shows a section along line III-III in FIG. 1;

FIG. 4 is an isometric view of the haulm lifting and separating apparatus of FIG. 2;

FIG. 5 is a view similar to FIG. 2 but showing a first variant of the embodiment shown in FIGS. 1 to 4;

FIG. 6 is a view similar to FIG. 5 but indicating a second variant of the embodiments shown in FIGS. 1-5;

FIG. 7 is a view similar to FIGS. 5 and 6 but indicating a third variant of the embodiments shown in FIGS. 1-5; and

FIG. 8 is a view similar to FIG. 5 but indicating a fourth variant of the embodiments shown in FIGS. 1-5.

### DETAILED DESCRIPTION

In the following a variety of embodiments are disclosed using similar reference numerals for like or similar elements.

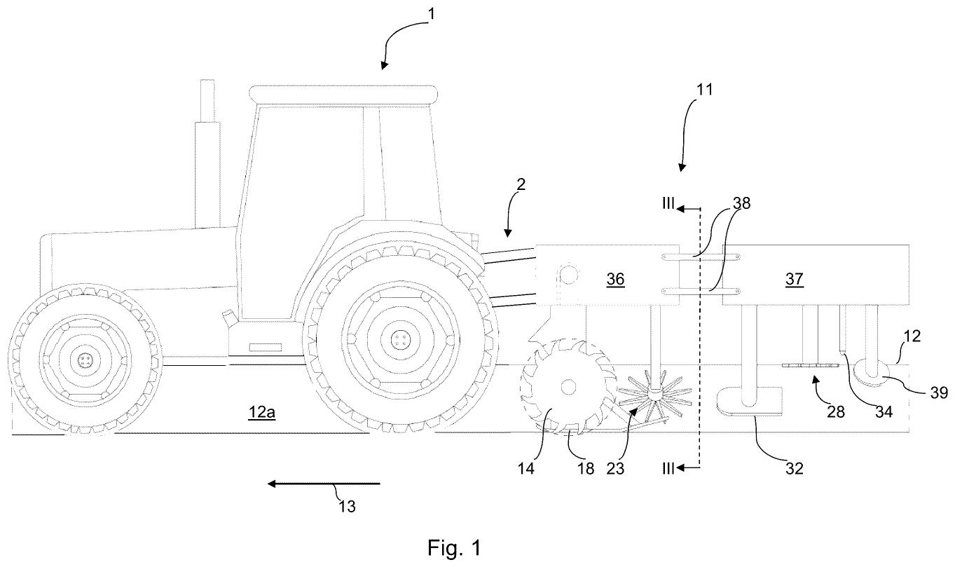

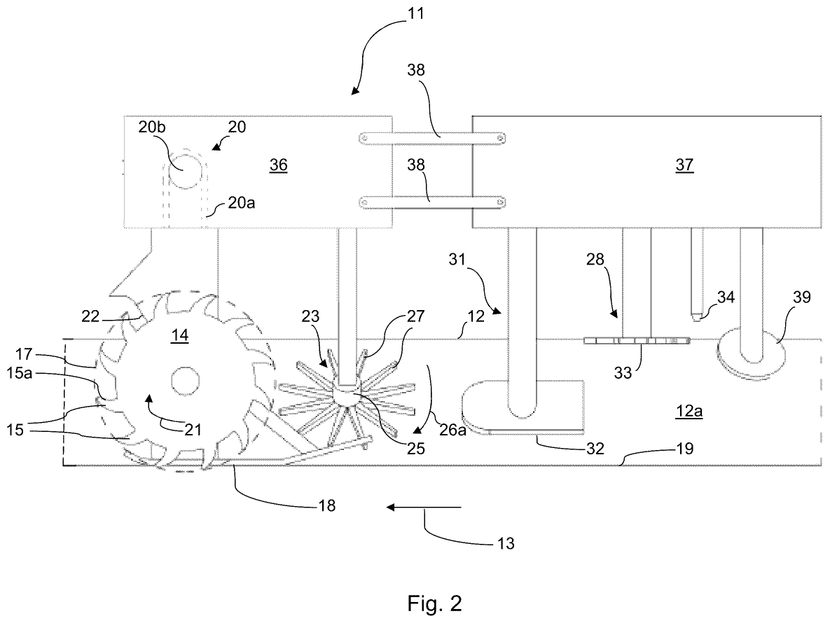

FIG. 1 and FIGS. 2 to 4 show a tractor 1 (FIG. 1) and a haulm lifting and separating apparatus 11 for separating and lifting haulms of a row 12 of crops (not shown per se) in an agricultural field comprising crops growing in rows 12. In the example shown, it should be understood that the crops are growing in rows, a row being represented by the top of a ridges 12a on or in which the crop is growing. The apparatus has a direction of travel 13 in operation.

As indicated in FIG. 1 the haulm lifting and separating apparatus 11 is attached to the tractor 1 by the three-point suspension 2 of the tractor 1. Electric and/or hydraulic power lines or a mechanical shaft connected to the PTO (power take off) of the tractor to supply power to the haulm lifting and separating apparatus 11 are not shown, but the skilled person will understand that such will be provided.

The apparatus comprises at least one driven moving lifting and separating means in the form of a circulating, possibly circular, element 14 adapted to be positioned next to the row 12 of crops, in the present embodiment next to the ridge 12a, and the circulating element 14 comprises a series of peripheral protrusions 15 circulating in a plane 16a, 16b, which is extending parallel to the direction of travel 13 and is extending upwards in a direction with a vertical component. In the present embodiment the plane is extending substantially vertically. The protrusions 15 are circumscribing an area of passage 17 during circulation.

A ground abutment 18 is positioned next to a lower portion of the area of passage 17 to define the position of said lower portion relative to the ground 19. Thus, it is possible to let the protrusions 15 sweep above the ground without breaking up the same during operation or to let the protrusions dig for example, 1½ cm into the ground to pick-up haulms that have been pressed down below the surface of the ground.

A drive 20 for the circulating element 14 is adapted to drive the circulating element 14 in a direction of circulation 21 whereby the protrusions 15 are moving in the direction of travel 13 at the lower portion of the area of passage 17. The drive 20 may comprise a sprocket chain 20a extending between a first sprocket wheel (not shown) on a shaft 20b driven by for example, a hydraulic motor (not shown) and second sprocket wheel (not shown) fixedly connected to a shaft 114 on which the circulating element 14 is mounted.

In the present embodiment, a shear 22 is positioned next to a periphery of the area of passage 17. During operation the protrusions 15 pass closely by the shear 22 and the tearing or cutting of the haulms is facilitated thereby.

Forward edges 15a of the protrusions 15, relative to the direction of rotation, are, in the embodiment shown, leaning forward in the direction of rotation 21 relative to a radial direction and they are concave to facilitate capture of haulms during the circulating movement the protrusions 15. Thus, during the circulating movement of the circulating element 14, and thereby of the protrusions 15 at a relatively high speed, the latter will catch haulms at a low level determined by the ground abutment 18 and lift and tear the haulms, in the embodiment shown in cooperation with the shear 22.

In the embodiment shown two circulating elements 14a, 14b are arranged as a twin-element comprising two series of peripheral protrusions 15 circulating in respective, mutually parallel planes 16a, 16b. A part of the drive 20, including the sprocket chain 20a is for practical reasons arranged between the parallel planes 16a, 16b, and likewise the shears 22 for the respective circulating elements 14a, 14b are arranged between the parallel planes 16a, 16b.

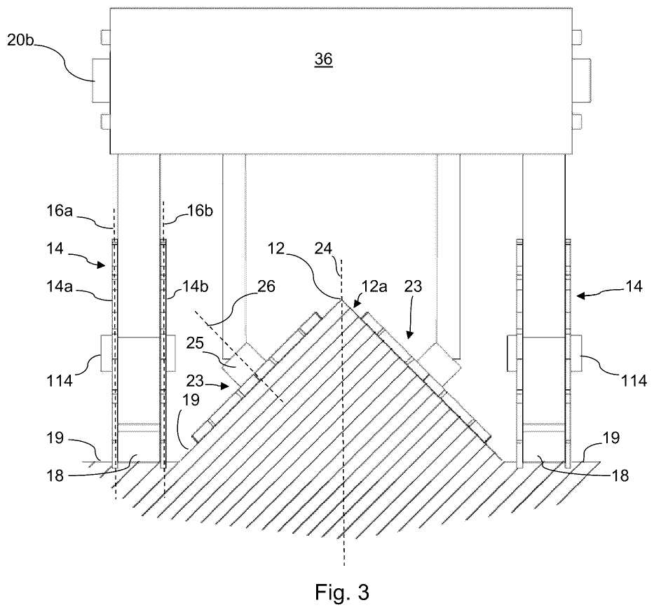

As seen in FIG. 1 and especially in FIG. 3, two circulating elements 14 are included and adapted to be positioned on either side of the row 12 of crops.

While in the embodiments schematically shown in FIGS. 1-5, the circulating element(s) 14 are shown as circular elements for example, as wheels with peripheral protrusions, alternatives are envisaged. Thus, the function of the peripheral protrusions 15, to engage with haulms to lift and tear or cut the same, could be performed by protrusions attached for example, to a chain circulating in a manner similar to the chain of a chain saw. Thus, a chain carrying protrusions might be circulating around a chain wheel or guide held close to the ground under the control of a ground abutment similar to the ground abutment 18 and around another, driven, chain wheel.

Behind the circulating element 14 relative to the direction of travel 13, a haulm lifting element or haulm engaging and lifting element 23 is arranged between the track of the circulating element 14 and a vertical plane 24 extending along and through the centre of the row 12.

In the embodiments shown, the haulm lifting element 23 is a driven, circulating, namely rotating element, which is formed as a wheel with peripheral, second protrusions 27. The wheel of the haulm lifting element 23 is attached to a driving element 25 at one side to be rotating around an axis 26 in a direction of rotation 26a, and the opposite side of the wheel is facing the ground, for example, the slanted ground of the ridge 12a as best seen in FIG. 3. The driving element may for example, be a hydraulic motor, an electric motor, or another power transferring means. In the embodiments shown, the side of the wheel facing the ground is shown to be plane, but it may for example, be concave for the protrusions 27 to be positioned closer to the ground than the centre of the wheel. Further the wheel may, as shown, especially in FIG. 3, be positioned with its side facing the ground parallel to the ground but said side may alternatively be tilted slightly relative to the ground for example, for the leading part of said side, relative to the direction of travel 13, to be positioned closer to the ground than the trailing part. It should be noted that though in FIG. 3 the haulm engaging and lifting element 23 is shown to touch the surface of the ridge 12a, preferably the haulm lifting element 23 is kept slightly above the surface of the ridge 12a in order not to dig into said surface. The haulm lifting element 23 lift and centre the haulms relative to the vertical plane 24 and the row 12 of crops.

In the embodiments shown in the figures the haulm lifting and separating apparatus 11 comprising a defoliating device 28 for separating the haulms from the roots of the crops. The defoliating device 28 is positioned centrally relative to the row 12 of crops to be processed and behind the circulating element 14 relative to the direction of travel 13.

In the embodiments shown the defoliating device 28 is a haulm cutting apparatus comprising a first, rotatable shear 29 rotatable around an axis, which in the embodiments shown is vertical, and a counter shear 30 in the form of a likewise rotatable shear 30a rotatable around an axis, which in the embodiments shown is vertical for cooperation with the first, rotatable shear 29. The first, rotatable shear 29 and counter shear 30 are positioned in a side-by-side relationship relative to the direction of travel 13. In the embodiments shown the first, rotatable shear 29 and the counter shear 30 each comprises a circular disc 33 with a recessed rim portion.

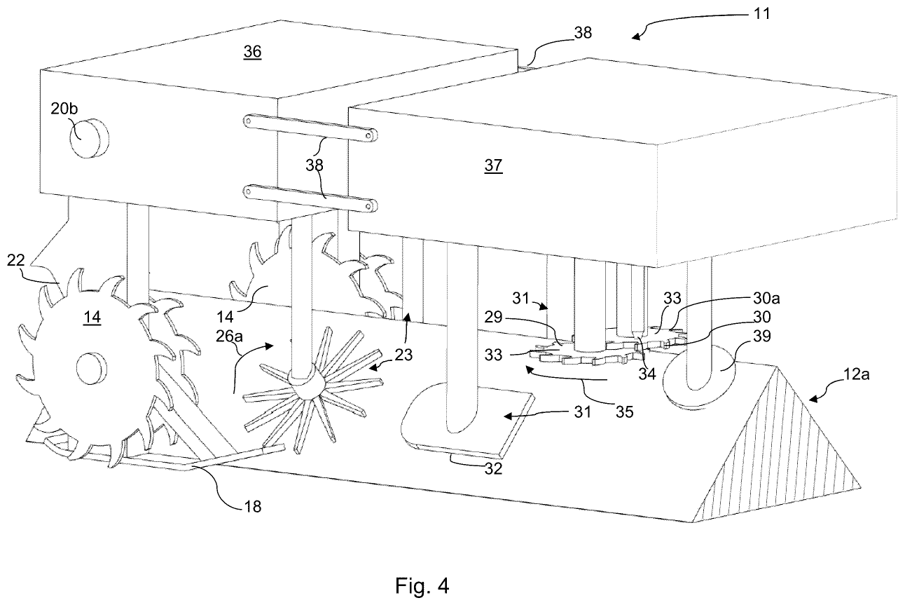

As indicated on FIG. 4 by arrow 35, the first rotatable shear 29 is driven in a clockwise direction during operation. The rotatable counter shear 30 is driven in a counter-clockwise direction at a different rotational speed than the first rotatable shear 29 as it is further disclosed in the above-mentioned WO 2020/164672 A1. During operation stems of the crop will be caught by the recesses of the rims of the first, rotatable shear 29 and the counter shear 30 and due to the difference of the rotational speeds thereof the stems will be cut or crushed, and the haulms will be separated from the roots of the crop plants, as explained in WO 2020/164672 A1.

In the embodiment schematically shown in FIGS. 1-4, the haulm lifting and separating apparatus 11 comprises a first frame part 36, schematically shown as a box, and the circulating elements 14, 14a, 14b and the haulm engaging and lifting elements 23 are suspended by said first frame part 36. A second frame part 37, likewise schematically shown as a box, is shown to be connected to the first frame 36 by parallel pivoted arms 38 allowing the second frame part 37 to move by parallel shifting up and down relative to the first frame part 36.

The defoliating device 28 is suspended by the second frame part 37 which for example, houses a drive, not shown, for driving the first, rotatable shear 29 and the counter shear 30 as mentioned above. Further the second frame part 37 is provided with second ground abutments in the form of lateral and vertical guiding means 31 for guiding the defoliating device 28 relative to the crops, and in the embodiment shown the lateral and vertical guiding means 31 comprise abutment surfaces 32 for abutment on opposite slanted ground surfaces of a ridge 12a.

When, as in the embodiment schematically shown in FIGS. 1-4, the haulm lifting and separating apparatus 11 comprises on one hand ground abutments 18 for controlling the position of the peripheral protrusions 15 of the circulating elements 14, 14a, 14b relative to the ground in the lower part of the areas of passage 17, and further comprises lateral and vertical guiding means 31 for guiding the defoliating device 28, it is possible to construct the haulm lifting and separating apparatus 11, like in the embodiment shown in FIGS. 1-4, with the circulating elements 14, 14a, 14b and haulm lifting elements 23 mounted in mutually fixed positions for example suspended by the first frame part 36, while the defoliating device 28 is movable relative thereto being suspended by the second frame part 37 which is movable relative to the first frame part 36.

It is noted that in the embodiments shown in FIGS. 1-5 the circulating elements 14, 14a, 14b constitutes as well driven moving haulm engaging element that is unshielded towards the ground, said haulm engaging element being in the form of a circulating circular elements adapted to be positioned next to the row of crops, said circulating element 14 comprising a series of peripheral haulm engaging protrusions 15 circulating in a plane 16a, 16b, said plane 16a, 16b extending generally parallel to the direction of travel 13 and extending upwards in a direction with a vertical component, as driven moving haulm separating means in the form of a circulating circular element 14 adapted to be positioned next to the row 12 of crops, said circulating element 14 comprising a series of peripheral haulm separating protrusions 15 circulating in a plane 16a, 16b, said plane 16a, 16b extending upwards in a direction with a vertical component, the haulm engaging element and the haulm separating means being one and the same.

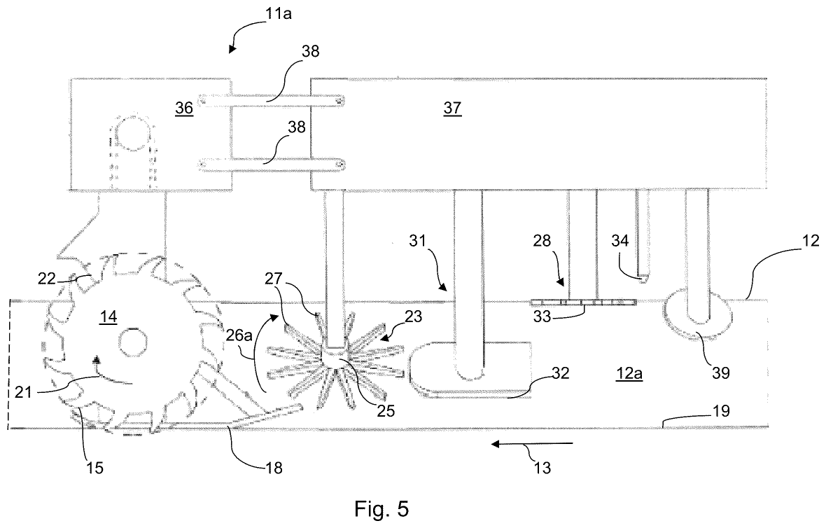

FIG. 5 shows an embodiment of the haulm lifting and separating apparatus 11a in which, the haulm lifting elements or haulm engaging and lifting elements 23 is suspended by the second frame part 37. Thus, the haulm lifting elements 23 are in a fixed position relative to the defoliating device 28 and the position of the haulm lifting elements 23 relative to the ground are controlled by second ground abutments in the form of the lateral and vertical guiding means 31.

In a further embodiment, not shown, the haulm lifting, and separating apparatus might be constructed with the circulating elements 14, 14a, 14b, the haulm lifting elements 23, and the defoliating device 28 mounted in fixed positions relative to each other. Thus, the first and the second frame part might be constructed as parts of a unitary frame part.

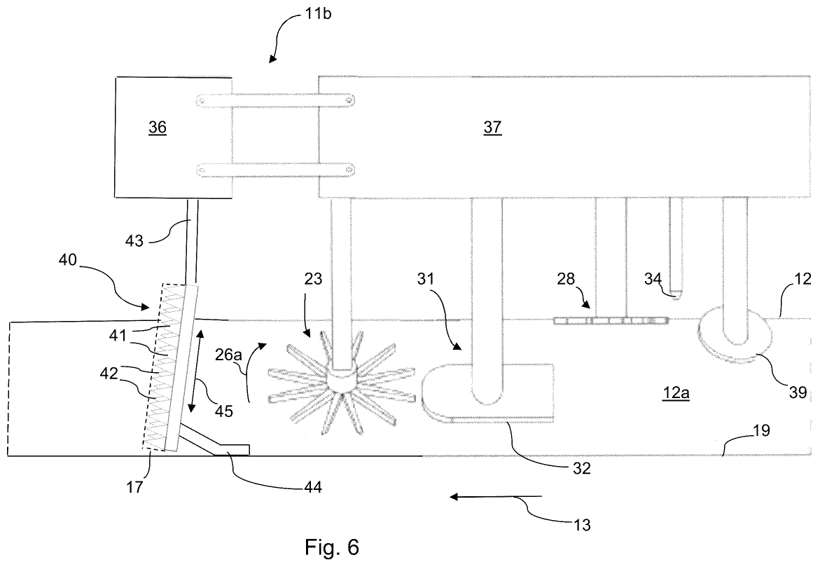

FIG. 6 illustrates an embodiment of the haulm lifting and separating apparatus 11b in which, compared to the embodiments shown respectively in FIGS. 1-4 and in FIG. 5, the circulating elements are substituted by reciprocating elements in the form of finger bar cutters 40. The finger bar cutters 40 or reciprocating knife cutter bars are elements of a general construction generally known per se for example, in relation combine harvesters, hedge cutters, etc.

Being a side view, FIG. 6 only shows one of the two finger bar cutters 40 the other one being hidden behind the one shown.

The finger bar cutter 40 comprises a 1^{st} set of knives 41 constituted by a set of peripheral protrusions and a 2^{nd} set of knives 42 constituted by another set of peripheral protrusions. The 1^{st} and the 2^{nd} set of knives 41, 42 are reciprocating relative to each other in the direction of double arrow 45, for example, in a longitudinal direction of the finger bar cutter 40, as it is generally known per se.

A ground abutment 44 is attached to the finger bar cutter 40 to define or control the position of the lower end of the finger bar cutter 40 or the lower end or the area of passage 17 of the finger bar cutter 40 and thus of the 1^{st} and the 2^{nd} set of knives 41, 42.

The 1^{st} and the 2^{nd} set of knives 41, 42 may both perform a reciprocating motion in mutually opposite phase or one of the 1^{st} and the 2^{nd} set of knives 41, 42 may be stationary relative to a frame of the apparatus while the other of the 1^{st} and the 2^{nd} set of knives 41, 42 performs a reciprocating, for example, oscillating movement.

Whereas, in FIG. 6 the haulm lifting element or haulm engaging and lifting element 23 is shown to suspended from the second frame part 37, like in FIG. 5, it should be understood, that the haulm engaging and lifting elements 23 may be suspended from the first frame part 36, as is the case with the embodiment shown in FIGS. 1-4, whether the moving separating means are finger bar cutters as shown in FIG. 6 or circulating elements as shown in FIGS. 1-4.

Relating to the embodiment shown in FIG. 6 it is noted that whereas the finger cutter bar 40 constitutes a driven moving haulm separating means in the form of a reciprocating element 40 adapted to be positioned next to the row 12 of crops, said reciprocating element 40 comprising a series of peripheral haulm separating protrusions 41, 42 reciprocating in a plane, said plane extending upwards in a direction with a vertical component, and the haulm engaging and lifting elements 23 constitutes a driven moving haulm engaging element that is unshielded towards the ground, said haulm engaging element being in the form of a circulating circular element 23 adapted to be positioned next to the row 12 of crops, said circulating element 23 comprising a series of peripheral haulm engaging protrusions circulating in a plane, said plane extending generally parallel to the direction of travel 13 and extending upwards in a direction with a vertical component.

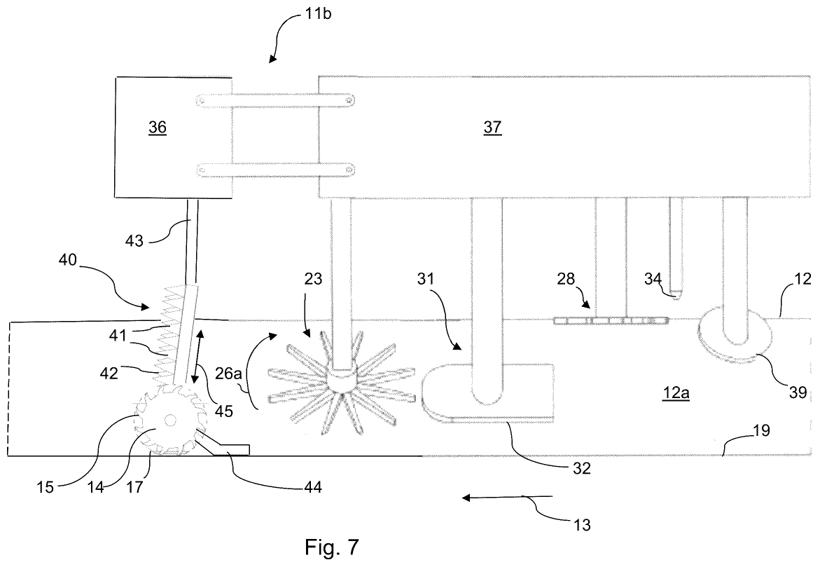

FIG. 7 indicates an embodiment similar to the embodiment indicated on FIG. 5 except for the following: Whereas in FIG. 5 a relatively large circular circulating element 14 is provided together with a shear 22 to cooperate with the peripheral protrusions 15 of the circulating element 14, in the embodiment of FIG. 7 a smaller circular circulating element 14 is provided and instead of the shear 22 a finger cutter bar 40 with a 1^{st} set of knives 41 and a 2^{nd} set of knives 42 is provided.

In operation of the embodiment of FIG. 7, the peripheral protrusions 15 will engage with the haulms and lift the same into engagement with the finger cutter bar 40 which will cut and thus separate the haulms.

Whereas in the embodiments shown in FIGS. 1-5, a stationary shear 22 is provided to be positioned next to a periphery of the area of passage 17 of the peripheral protrusions 15 of the circular circulating elements 14, 14a, 14b, and in the embodiment shown in FIG. 6, a finger bar cutter 40 is provided which comprises a 1^{st} and a 2^{nd} set of knives 41, 42 whereby a first of the two sets of knives may be regarded as peripheral haulm separating protrusions and the second of the two sets of knives may be regarded as, possibly stationary, shears positioned next to the area of passage of the first set of knives, in the embodiment shown in FIG. 7, a finger cutter bar 40 is provided to constitute a shear positioned next to the periphery of the area of passage 17.

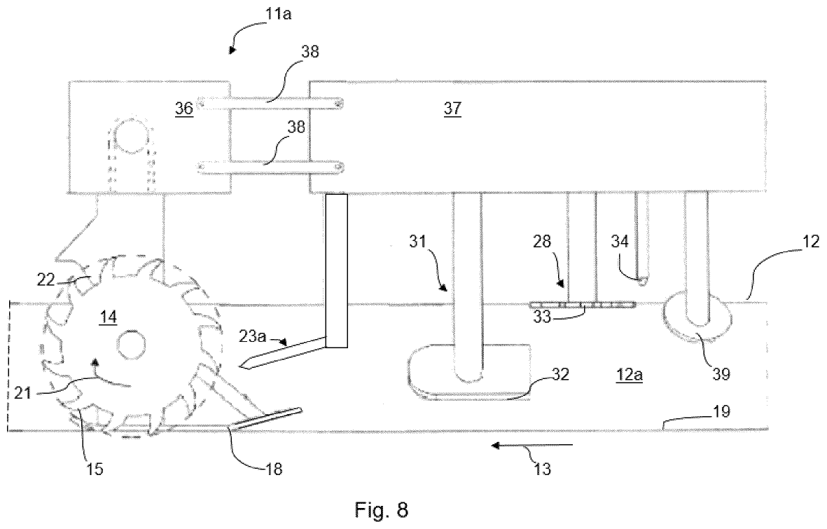

FIG. 8 shows an embodiment similar to the embodiment shown in FIG. 5 but wherein the driven, rotating haulm lifting element 23 has been substituted by a spear-like haulm lifting element 23a. The spear-like haulm lifting element 23a may be embodied in various ways. Thus, as schematically shown in FIG. 8 the spear-like haulm lifting element 23a may be constituted by a fixed slender element pointing oblique downwards in the direction of travel 13. Alternatively, the spear-like haulm lifting element 23a may be a bend element similar to the bend elements of the above-mentioned NL 7905829 A and it may include a rotating roller as shown in NL 7905829 A. In another alternative the spear-like haulm lifting element 23a may be constituted by a slender element for example, pointing oblique downwards in the direction of travel 13 and rotating around a longitudinal axis thereof such slender rotating elements possibly being provided with an auger winding for transporting the haulms rearwardly towards the defoliating device 28 when such device is present.

Whereas, as mentioned above, it is the experience of the present inventor that such spear-like elements are prone to get caught and stuck resulting in wreckage or breaking up the soil potentially revealing potatoes in the ground subjecting the same to sunlight, which ruins the potatoes, in combination with a preceding circulating element, like the circular element 14, that will lift and course separation of the haulms, the spear-like element need not have its forward end positioned too close the soil because the haulm has been lifted prior to the engagement of the spear-like haulm lifting element 23a with the haulms and accordingly the risk of encounter of the forward end of the spear-like element with the ground may be minimized, while the spear-like haulm lifting element 23a still performs a desired haulm lifting effect.

In an embodiment comprising two reciprocating or circulating elements on either side of a row of crops these two reciprocating or circulating elements are adapted to move independently up and down to be able to follow the contour of the field on the respective sides of the row of crops independently. This ability to move independently may be obtained in different ways, for example, the respective reciprocating or circulating elements may be independently suspended from the respective frame part, such as the first frame part 36, or the respective frame part, such as the first frame part 36 is able to tilt around a longitudinal axis extending in the direction of travel during operation. In the embodiments shown an optional spraying device is included with a nozzle 34 provided behind the defoliating device 28, preferably for spraying a weeding agent onto residuals of haulms. When removing the haulms from the roots by a defoliating device, for example, a haulm cutting apparatus, it may be intended that growth should be stopped to prevent the plant from growing new haulms, for example, to instead promote the growth and development of the crop proper, for example. potatoes. Whereas defoliating or haulm cutting may be intended as an alternative to a chemical treatment, a slight chemical treatment may be added by this embodiment.

In the embodiments shown, like in the prior art haulm cutting apparatus disclosed in the above-mentioned WO 2020/164672 A1, an optional harrow disc 39 is provided for shifting soil onto the remains of the cut haulms. Further, other auxiliary tools or devices taught by WO 2020/164672 A1 may be implemented as the skilled person will appreciate.

Whereas a variety of embodiments has been described above with reference to different figures of the drawing in which embodiments different elements performing certain functions are presented, it should be noted that the different elements may be combined in any way within the invention as long as the overall function of lifting and separating haulms is performed.

What is claimed is:

1-16. (canceled)

17. A haulm lifting and separating apparatus for lifting and separating haulms of rows of crops in an agricultural field comprising crops growing in rows, possibly on ridges, said apparatus being adapted for separating the haulms prior to said haulms being separated from their respective roots, said apparatus having a direction of travel in operation, and said apparatus comprising:
at least one driven moving haulm engaging element that is unshielded towards the ground, said haulm engaging element being in the form of a circulating, possibly circular, element adapted to be positioned next to a row of crops, said circulating element comprising a series of peripheral haulm engaging protrusions circulating in a plane, said plane extending upwards in a direction with a vertical component,
said haulm engaging protrusions defining an area of passage during circulation;
at least one driven moving haulm separating means in the form of a reciprocating or circulating, possibly circular, element adapted to be positioned next to a row of crops, said reciprocating or circulating element comprising a series of peripheral haulm separating protrusions reciprocating or circulating in a plane, said plane extending upwards in a direction with a vertical component;
a ground abutment positioned next to a lower portion of the area of passage to define the position of said lower portion relative to the ground;
at least one drive for driving the reciprocating or circulating element(s); and
a shear positioned laterally next to a periphery of the area of passage.

18. The haulm lifting and separating apparatus according to claim 17, wherein the haulm engaging element and the haulm separating means are one and the same.

19. The haulm lifting and separating apparatus according to claim 17, wherein at least one of the reciprocating or circulating elements is a circulating element and the drive for said circulating element is adapted to drive the circulating element in a direction of circulation whereby the haulm engaging protrusions and/or haulm separating protrusions are moving in the direction of travel at the lower portion of the area of passage.

20. The haulm lifting and separating apparatus according to claim 19, wherein two of said reciprocating or circulating elements are arranged as a twin-element comprising two series of peripheral protrusions reciprocating or circulating in respective, mutually parallel planes, and wherein preferably at least part of the abutment as a common abutment is positioned between the parallel planes.

21. The haulm lifting and separating apparatus according to claim 19, wherein two of said circulating elements are arranged as a twin-element comprising two series of peripheral protrusions circulating in respective, mutually parallel planes, preferably at least a part of the drive being arranged between the parallel planes, and preferably shears are arranged between the parallel planes.

22. The haulm lifting and separating apparatus according to claim 17, wherein two reciprocating or circulating elements are adapted to be positioned on either side of the row of crops.

23. The haulm lifting and separating apparatus according to claim 17, wherein the haulm engaging element is an individual element relative to the haulm separating means.

24. The haulm lifting and separating apparatus according to claim 17, wherein behind the reciprocating or circulating element relative to the direction of travel, a haulm lifting element is arranged between the track of the reciprocating or circulating element and a vertical plane intended to extend along and through the center of the row.

25. The haulm lifting and separating apparatus according to claim 24, comprising a second ground abutment for guiding the haulm lifting element and wherein the haulm lifting element is movable relative to the haulm separating means in a plane perpendicular to the direction of travel.

26. The haulm lifting and separating apparatus according to claim 24, wherein said haulm lifting element is a driven, circulating, preferably rotating element.

27. A haulm lifting and separating apparatus according to claim 26, wherein the haulm lifting element is formed as a wheel with peripheral, second protrusions.

28. The haulm lifting and separating apparatus according to claim 17, comprising a defoliating device for separating the haulms from the roots of the crops, said defoliating device being positioned to be placed centrally relative to the row of crops to be processed and behind the reciprocating or circulating element relative to the direction of travel in operation.

29. The haulm lifting and separating apparatus according to claim 28, wherein the defoliating device is a haulm cutting apparatus comprising a first, rotatable shear rotatable around an axis of rotation extending in a direction with a vertical component, and a counter shear for cooperation with the first, rotatable shear, wherein the first, rotatable shear and counter shear are positioned in a side-by-side relationship relative to the direction of travel.

30. The haulm lifting and separating apparatus according to claim 28, comprising lateral and vertical guiding means for guiding the defoliating de-vice relative to the crops, wherein preferably the lateral and vertical guiding means comprise abutment surfaces for abutment on opposite slanted ground surfaces of a ridge.

31. The haulm lifting and separating apparatus according to claim 29, wherein at least one of the first, rotatable shear and the counter shear comprise a circular disc with a recessed rim portion.

32. The haulm lifting and separating apparatus according to claim 28, wherein a spraying device is included with a nozzle provided behind the de-foliating device, preferably for spraying a weeding agent onto residuals of haulms.

33. A haulm lifting and separating apparatus for lifting and separating haulms of rows of crops in an agricultural field comprising crops growing in rows, possibly on ridges, said apparatus being adapted for separating the haulms prior to said haulms being separated from their respective roots, said apparatus having a direction of travel in operation, and said apparatus comprising:
at least one driven moving haulm engaging element that is un-shielded towards the ground, said haulm engaging element being in the form of a circulating, possibly circular, element adapted to be positioned next to a row of crops, said circulating element comprising a series of peripheral haulm engaging protrusions circulating in a plane, said plane extending parallel to the direction of travel and extending upwards in a direction with a vertical component, said haulm engaging protrusions defining an area of passage during circulation;
at least one driven moving haulm separating means in the form of a reciprocating or circulating, possibly circular, element adapted to be positioned next to a row of crops, said reciprocating or circulating element comprising a series of peripheral haulm separating protrusions reciprocating or circulating in a plane, said plane extending upwards in a direction with a vertical component;
a ground abutment positioned next to a lower portion of the area of passage to define the position of said lower portion relative to the ground;
at least one drive for driving the reciprocating or circulating element(s); and
a shear positioned laterally next to a periphery of the area of passage.

34. A haulm lifting and separating apparatus for lifting and separating haulms of rows of crops in an agricultural field comprising crops growing in rows, possibly on ridges, said apparatus being adapted for separating the haulms prior to said haulms being separated from their respective roots, said apparatus having a direction of travel in operation, and said apparatus comprising:
at least one driven moving haulm engaging and separating element that is unshielded towards the ground, said haulm engaging and separating element being in the form of a circulating, possibly circular, element adapted to be positioned next to a row of crops, said circulating element comprising a series of peripheral haulm engaging protrusions circulating in a plane, said plane extending upwards in a direction with a vertical component,
said haulm engaging protrusions defining an area of passage during circulation;
a ground abutment positioned next to a lower portion of the area of passage to define the position of said lower portion relative to the ground;
at least one drive for driving the reciprocating or circulating element(s); and
a shear positioned laterally next to a periphery of the area of passage.
